(19) United States
(12) Patent Application Publication
(10) Pub. No.: US 2009/0055189 A1
(43) Pub. Date: Feb. 26, 2009

(54) Automatic Replacement of Objectionable Audio Content From Audio Signals

(76) Inventors: Anthony Edward Stuart, Zionsville, IN (US); Rajeev Madhukar Sahasrabudhe, Fishers, IN (US); Scott Allan Kendall, Westfield, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/887,792

(22) PCT Filed: Apr. 14, 2005
(86) PCT No.: PCT/US2005/012675

§ 371 Date: Oct. 3, 2007

(51) Int. Cl. G10L 21/00

(52) U.S. Cl. 704/270

(57) ABSTRACT

A method, apparatus and system are provided for the automatic replacement of potentially objectionable audio content from an audio signal in real time. In one embodiment of the present invention, the selective filtering of objectionable audio content from an audio signal is accomplished by first marking objectionable audio content in the audio signal with filtering information that identifies the type of objectionable audio content (e.g., crude language, ethnic and racial slurs, cursing, strong profanity) and storing the filtering information and the corresponding location of the objectionable audio content for that particular audio signal. Objectionable audio content having filtering information corresponding to a stored replacement content code determined from a predetermined replacement setting is then automatically replaced with an audio clip corresponding to the replacement setting.

### TECHNICAL FIELD

This invention relates to media systems, and more particularly, to replacing objectionable audio content from audio signals in real time.

### BACKGROUND ART

It is a common desire of many listeners of audio signals found in such media as television, movies, music, and other programs to filter portions of the audio of such programs. For example, many parents prohibit their children from watching cable television broadcasts, certain movies, or listen to certain music because the audio of the program can include inappropriate language that is unsuitable for children. In addition, since the parent has not heard the audio, the parent can not know whether the content of the program is inappropriate for the children or not. Consequently, parents can inadvertently permit their children to listen to a program not knowing portions of it are inappropriate, or conversely, can prohibit listening of the program even though its content does not include any inappropriate portions.

In an effort do solve this dilemma, the U.S. Federal Communications Commission has established provisions (EIA-608-B) for attaching parental guidelines (“ratings”) to broadcasts. According to the FCC guidelines, however, only one rating can be applied to any given program and that rating can not change during the course of the program. The inability to change the rating midway during the broadcast makes the FCC parental guideline system a “go or no-go” system. That is, either the entire program is deemed appropriate or inappropriate depending on the rating. Consequently, while the rating system is helpful to parents in determining whether to permit the child to view and listen to the entire broadcast or program, it does not facilitate filtering of portions of the program to prevent viewers (e.g., children) from hearing particular portions of the program that are objectionable.

There exists various prior art systems and methods that are based on or rely on the use of a government or industry-wide program rating system, such as the previously discussed rating system, that use a “V-chip” approach, or that use a proprietary rating system. Such systems are effective for blocking audio content that the user indicates should be blocked based on such content being associated with a specific rating. The specific ratings, however, are applied to an entire program and, as such, the systems that block audio content based on such ratings block or allow through the entire program. These systems are “go or no-go” systems, as discussed above. Either the entire program is deemed appropriate and let through or inappropriate and blocked depending on the rating. There is no capability in such systems for allowing the user to listen to a program, but to selectively identify and filter out objectionable audio content.

In addition, prior art systems exist that filter a closed caption and/or audio of a television program by comparing the words in the transmitted closed caption with a list of offensive words. When an offensive word is detected, the system will remove it from the closed caption stream so that it is not displayed on the television screen. Based on detection of the offensive word in the closed caption stream, the system mutes (i.e., turns off) the audio signal for a timed period. The system estimates the time at which it should start muting the audio and the length of the timed period. The disclosure indicates that the period of time for which the audio signal is turned off is flexible. Where a particularly objectionable word, or particular lengthy objectionable phrase is encountered, the audio signal can be turned off for a relatively long period of time. While the system is effective in filtering offensive words from the closed caption stream, filtering of the audio signal is based on an estimate and can result in audio that is not objectionable being blocked or audio that is objectionable getting through. In addition, in such prior art systems that block or mute an audio signal from a program, the blocking of the audio signal causes a program to sound choppy and are less enjoyable to a viewer or listener.

In other prior art solutions, a video signal contains embedded information regarding the location of objectionable audio content and that embedded information identifying the location of objectionable audio content is used in the muting or replacement of user selectable audio content. However, such prior art solutions require the modification of video signals to include such embedded information and do not work with video signals that have not been so modified.

Thus, notwithstanding the various systems and methods of the prior art, there is a need for a method and product that provides for the selective filtering of objectionable audio content from an audio signal and replaces the objectionable audio with acceptable audio clips such that disruption of the flow of the audio signal is minimized and such that the audio signal is not modified.

### BRIEF SUMMARY OF THE INVENTION

The present invention addresses the deficiencies of the prior art by providing a method, apparatus and system for automatically replacing objectionable audio content from audio sources.

In one embodiment of the present invention, a method for automatically replacing objectionable audio content from an audio signal in real time includes identifying objectionable audio content in the audio signal, determining a table of replacement events based on at least one selected replacement setting, wherein each of the replacement events includes filtering information that corresponds to the at least one replacement setting, and automatically replacing objectionable audio content in the audio signal with an audio clip corresponding to the replacement setting when it is determined that objectionable audio content in the audio signal matches the filtering information defined in the table of replacement events. In the method of the present invention it is not necessary for the audio signal that is to be filtered to include embedded information regarding the location of objectionable audio content in the audio signal.

In an alternate embodiment of the present invention, an apparatus for automatically replacing objectionable audio content from an audio signal in real time includes an identifier and recording block for identifying objectionable audio content in the audio signal and for storing location and filtering information for the objectionable audio content, a replacement events table based on at least one selected replacement setting, where each of the replacement events includes filtering information that corresponds to the at least one replacement setting, a filter selection/activation interface for, in conjunction with a user interface, selecting replacement settings, and a replacement controller for causing the automatic replacement of objectionable audio content in the audio signal with an audio clip stored in a audio replacement generation block, the audio clip corresponding to the replacement setting, and the automatic replacement occurring when it is determined that objectionable audio content in the audio signal matches the filtering information defined in the table of replacement events. In the event that an audio signal to be filtered also contains video, the apparatus of the present invention would further include demodulation and switching circuitry for separating the audio signal from a video signal.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a media system including a control unit in accordance with one embodiment of the present invention;

FIG. 2 depicts a more detailed high level block diagram of an embodiment of a control unit suitable for use in the media system of FIG. 1;

FIG. 3 depicts an embodiment of a menu system of the present invention;

FIG. 4 depicts a high level block diagram of an embodiment of a category sub-menu of the menu system of FIG. 3 in accordance with the present invention;

FIG. 5 depicts a high level block diagram of an embodiment of a member sub-menu for a category of objectionable audio content of the menu of FIG. 4;

FIG. 6 depicts the member sub-menu of FIG. 5 further comprising a sub-window for audio gender selection;

FIG. 7 depicts a method of automatically replacing objectionable audio content from an audio signal in accordance with one embodiment of the present invention;

FIG. 8 depicts a high level block diagram of a media system including a control unit in accordance with an alternate embodiment of the present invention; and

FIG. 9 depicts a high level block diagram of an embodiment of a control unit suitable for use in the media system of FIG. 8.

To facilitate understanding, identical reference numerals have been used, where possible, to designate identical elements that are common to the figures.

### DETAILED DESCRIPTION

The present invention advantageously provides a method, apparatus and system for automatically replacing objectionable audio content from audio sources. Although throughout the teachings herein and in various embodiments of the present invention, the aspects of the present invention are described as automatically replacing objectionable audio content from an audio signal, the specific embodiments of the present invention should not be treated as limiting the scope of the invention. It will be appreciated by those skilled in the art and informed by the teachings of the present invention that the concepts of the present invention can be advantageously applied to audio signals, audio/visual signals, or any other combined signals that comprise separable audio signals. As such, it should be understood that the use of the term audio signal throughout the teachings of the present invention should be interpreted as being representative of substantially any signal containing at least a portion of a separable audio signal.

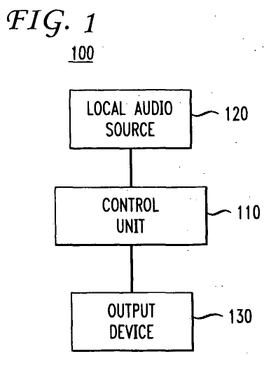

FIG. 1 depicts a high level block diagram of a media system including a control unit 110 in accordance with one embodiment of the present invention. More specifically, FIG. 1 depicts a media system 100 including a local audio source 120, an output device 130 and a control unit 110 in accordance with an embodiment of the present invention. The media system 100 of FIG. 1 filters audio from the local audio source 120 such that objectionable content is not communicated to the output device 130. In the media system 100 of FIG. 1, the local audio source 120 can comprise any source of audio such as a digital video disk (DVD) player, a compact disc (CD) player, a digital video recorder (DVR), a videocassette recorder, a laser disk player, or other suitable audio media player and the like. The output device 130 can comprise substantially any output device such as a display device for outputting video and audio information, a speaker system for outputting audio, and the like. Although in the media system 100 of FIG. 1, the control unit 110 of the present invention is depicted as comprising a stand-alone component, in alternate embodiments of the present invention, a control unit of the present invention could be integrated into a local audio receiver or a local audio source, such as the local audio source 120 of the media system 100 of FIG. 1. Alternatively, the control unit of the present invention can be integrated into an output device, such as the output device 130 of the media system 100 of FIG. 1.

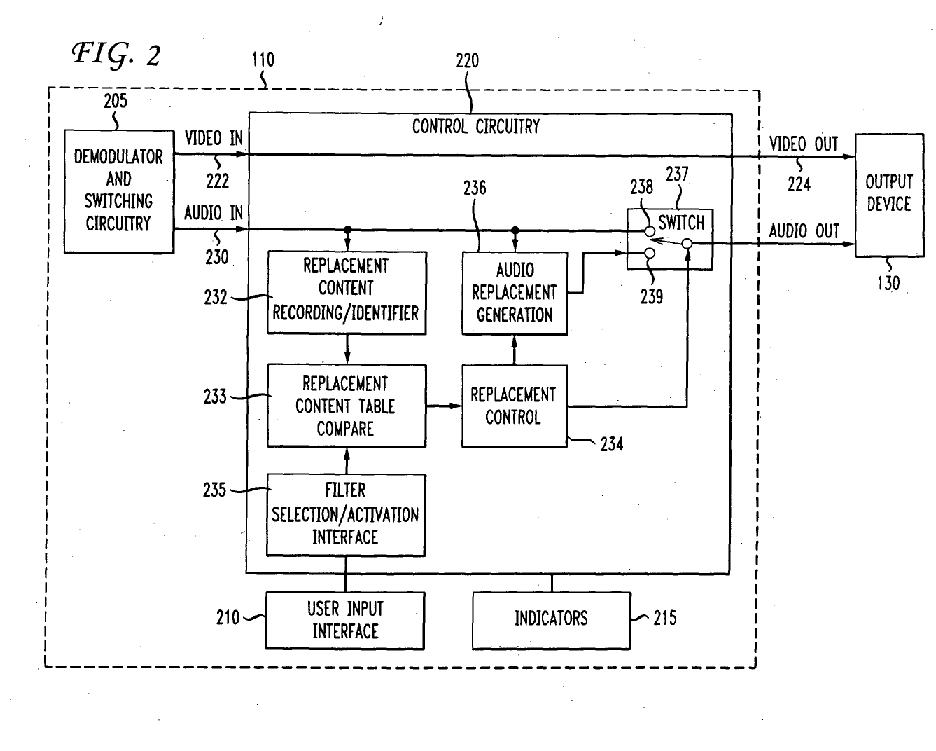

The unfiltered audio signals (e.g., movie audio, music video audio or stand alone audio, such as music) from the local audio source 120 is received by the control unit 110 of the present invention. FIG. 2 depicts a high level block diagram of an embodiment of a control unit 110 suitable for use in the media system 100 of FIG. 1. More specifically, the control unit 110 of FIG. 2 illustratively comprises a demodulation and switching circuit 205, a user input interface 210, and control circuitry 220. The user input interface 210 of the control unit 110 can comprise wireless remote controls, pointing devices, such as a mouse or a trackball, voice recognition systems, touch screens, on screen menus, buttons, and the like. As depicted in FIG. 2, the control unit 110 of the present invention can also optionally include indicators 215. The indicators 215 can provide visible indications of the state of the control unit 110 to the user (i.e., to indicate when the control unit is performing filtering and at what level). The indicators 215 of a control unit of the present invention, such as the control unit 110, can comprise light emitting diodes, lamps, liquid crystal displays, and the like. The indicating functions of the indicators 215 can be provided by the control circuitry 220 of the control unit 110 to generate on-screen indicator images.

The demodulation and switching circuit 205 of the control unit 110 receives unfiltered signals from the local audio source 120. The demodulation and switching circuit 205 demodulates the output signals from the local audio source 120. Switching circuitry within the demodulation and switching circuit 205 directs audio signals from the output of the local audio source 120 to the control circuitry 220 via a first signal path 207 and directs any video signals in the output of the local audio source 120 to the control circuitry 220 via a second signal path 209. The demodulation and switching circuit 205 can be provided with suitable digital communications capabilities to handle digital information from sources such as the local audio source 120.

The control circuitry 220 of the control unit 110 of FIG. 2 includes a video path 222 and an audio path 230. The video path 222 of the control unit 110 directs any input video signal to a video output 224 of the control unit 110. That is, no processing is performed by the control unit 110 on an input video signal. A video signal is fed through the control unit 110 to the video output 224 of the control unit 110 and ultimately to a video input of a display device (not shown), or in the embodiment of FIG. 1, to a video input of the output device 130, which in this case would also output video.

The audio path 230 of the control unit 110 comprises a replacement content recording and identifier block 232, a replacement content table compare block 233, a replacement control block 234, a filter selection/activation interface block 235, an audio replacement generation block 236 and a switch block 237. The functional blocks (e.g., replacement content recording and identifier block, filter selection/activation interface block, etc.) in the audio path 230 of the control unit can be implemented in hardware, software, or a combination of hardware and software.

A user controls the settings of the control circuitry 220 by entering commands via the user input interface 210. For example, in one embodiment of the present invention, a user trains or teaches the control unit 110 what portions of an audio signal (e.g., a song or a movie) contains objectionable audio content. More specifically, in this embodiment of the present invention, a user initially uses the local audio source 120 to play the audio signal and, using the user input interface 210 and the control unit 110 identifies the locations of objectionable audio content in the audio signal. For example, in one embodiment of the present invention, the user uses the user input interface 210 to store, in the replacement content recording and identifier block 232, time marks of the audio signal to identify the location and duration of the objectionable audio content. The entire audio signal can be played by the user for identifying any objectionable audio content as described above. A user can enter the time marks as described above by, for example, entering the start time and the end time of objectionable audio to be saved in for example, the replacement content recording and identifier block 232, or alternatively, the user input interface 210 can interact with the control circuitry 220 such that a single button can be depressed to indicate the start of objectionable audio and the same, or alternatively a second button, can be depressed to indicate the end of the objectionable audio. In the latter embodiment, the start and the stop time would then be recorded in the replacement content recording and identifier block 232 automatically to identify locations of objectionable audio. A control unit of the present invention, such as the control unit 110, can use a timer of the local audio source 120 to track the time of an input audio signal or can alternatively comprise its own timer (not shown). During the training of the present invention, a user can start, stop, pause, rewind, and/or fast forward an audio signal to identify the locations of objectionable audio content in an audio signal. That is, in various embodiments of the present invention, through user interaction, a control unit 110 can communicate a signal to the local audio source 120 to cause the audio signal to be started, stopped, paused, rewound, and/or fast forwarded.

In addition to identifying and recording the location of objectionable audio content in the audio signal, the audio signal is also identified. More specifically, an identifier for the audio signal, such as the title, is stored in the control unit 110 such that the control unit 110 is able to identify the specific audio signal if the control unit 110 again receives the audio signal. In one embodiment of the present invention, the audio signal is identified by a title of the audio signal that is determined from information in the audio signal itself. When an audio signal is unable to be identified by information in the audio signal itself, a user can be prompted to input an identifier for audio signal such that the audio signal can be recognized by the control unit 110 during subsequent applications. As such, the title given to the audio signal by the user must be recorded and stored to later identify the audio signal when received by the control unit 110. That is, before the same audio signal is played by the local audio source 120, a user would input the stored title to identify the audio signal and, as such, identify the locations of the objectionable audio content in that particular audio signal.

In alternate embodiments of the present invention, a user can receive information identifying objectionable material in audio signals by other means, such as a subscription service that identifies objectionable material in audio signals. Information regarding the location of objectionable material in a particular audio signal can be provided to the user by, for example, the subscription service for inputting into a control unit of the present invention, such as the control unit 110, via the user input interface 210. For example, a subscription service can provide a listing of the time locations of objectionable audio content for a specific audio signal (e.g., a movie, a song, etc) to a subscriber, enabling the subscriber to input and store the locations of the objectionable audio content into the replacement content recording and identifier block 232 of the control unit 110 for that specific audio signal. The user would again identify that specific audio signal for which the information was stored such that the specific audio signal can be recognized by the control unit 110. That is, the subscription service can provide information contained in the audio signal that can be used by the control unit 110 to identify that particular audio signal or, alternatively, the user can identify the audio signal by any means previously described herein.

Alternatively, a subscription service can provide information regarding the location of objectionable material in a particular audio signal to a subscriber on a medium which the subscriber can use to input the information into the replacement content recording and identifier block 232 of the control unit 110. For example, in such embodiments of the present invention, information regarding the location of objectionable material in a particular audio signal can be provided to a subscriber in a downloadable format on the internet such that the information can be downloaded over the Internet and copied onto a medium, for example a CD, for transfer to the control unit 110. In such embodiments of the present invention, the control circuitry 220 of the control unit 110 can further be adapted to receive information from a player of the medium, for example a CD player, such that the information regarding the location of objectionable material in a particular audio signal downloaded from the internet and copied onto the medium can be transferred to and stored in the replacement content recording and identifier block 232 of the control unit 110 using an external player of the medium. Alternatively, a control unit 110 of the present invention can further include a media player such that information regarding the location of objectionable material in a particular audio signal provided by a subscription service or other means can be transferred to and stored in the replacement content recording and identifier block 232 of the control unit 110 using the media player. In any event, the particular audio signal must also be identified in the control unit 110 using any of the means described above.

Once information regarding the objectionable audio content of a particular audio signal has been identified and stored in the replacement content recording and identifier block 232 of the control unit 110 and the audio signal itself had been identified, the control unit 110 of the present invention is able to selectively and automatically replace objectionable audio content from the identified audio signal. That is, in accordance with the present invention, an audio signal from the demodulation and switching circuit 205 is directed, via a second signal path 209, to the control circuitry 220. The replacement content recording and identifier block 232 of the control unit 110 examines the audio signal in an attempt to identify the audio signal. If the identification of the audio signal matches a stored identification in the replacement content recording and identifier block 232, a recorded list of information regarding objectionable audio content in the audio signal, such as the location and duration of the objectionable audio content, is communicated to the replacement content table compare block 233. In the replacement content table compare block 233, a user's choices made using the user input interface 210 and the filter selection/activation interface block 235 for whether or not an input audio signal should be filtered and even further, for which portions of an input audio signal should be filtered are compared to recorded list of objectionable audio content in the audio signal.

That is, as previously mentioned a user interacts with the control circuitry 220 of the control unit 110 via the user input interface 210. Using the user input interface 210 and the filter selection/activation interface block 235, a user can activate or deactivate the automatic replacement (filtering) of objectionable audio content in the audio signal via a menu system accessible via the user input interface 210 and maintained in the filter selection/activation interface block 235. More specifically, in one embodiment of the present invention, a control unit of the present invention, such as the control unit 110, can include a menu system for enabling a user to activate or deactivate the automatic replacement of objectionable audio content in the audio signal in accordance with the present invention. The menu system of the control unit 110 is accessible via the user input interface 210.

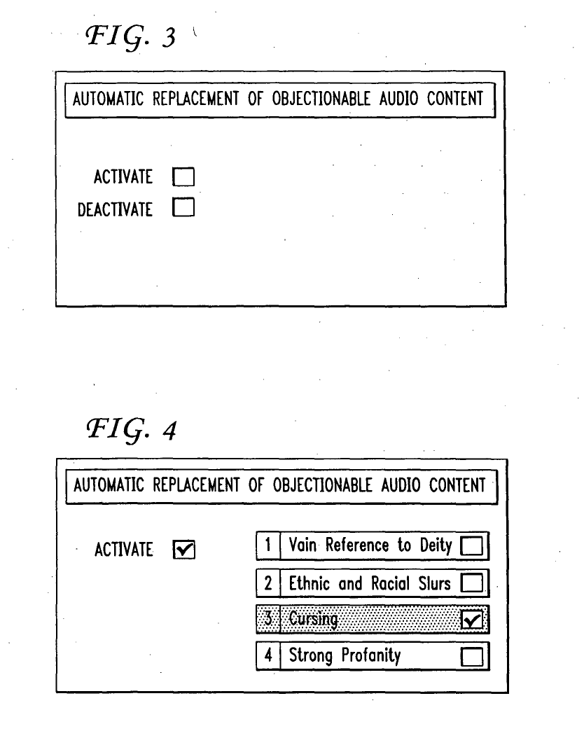

FIG. 3 depicts a high level block diagram of an embodiment of a menu system of the present invention. As depicted in FIG. 3, a first menu screen allows a user to choose to deactivate the automatic replacement of objectionable audio content in an input audio signal and as such to not have any filtering performed on the audio signal, or to choose to activate the automatic replacement of objectionable audio content in an input audio signal in accordance with the present invention. If the automatic replacement of objectionable audio content in an input audio signal is deactivated, the audio signal from the local audio source 120 is communicated through the control unit 110 to the output device 130 without interruption. However, if the automatic replacement of objectionable audio content in an input audio signal in accordance with the present invention is activated, previously identified objectionable audio content in an input audio signal is automatically replaced with pre-recorded audio in accordance with the present invention.

In one embodiment of the present invention, a control unit of the present invention, such as the control unit 110, can include a stored default previously recorded audio clip for automatically replacing objectionable audio content in an input audio signal. That is, when the automatic replacement of objectionable audio content in an input audio signal of the present invention is activated, the objectionable audio content is automatically replaced with replacement content, typically a stored default audio clip at each location of objectionable audio content in the audio signal. The stored audio clips can be canned audio clips from various sources, such as the Internet, movie and music clips available for consumer purchase or audio clips provided by a subscription service (or any combination thereof), provided with the control unit 110. Alternatively, a control unit of the present invention, such as the control unit 110, can further include a means, such as a microphone (internal or external), for recording an audio clip to be used as a default replacement audio clip for objectionable audio content in the audio signal. That is, in such an embodiment, a user can record an alternative audio clip (e.g., a recording of a user's voice, a recording of an actor's voice, etc.) to be used for the automatic replacement of objectionable audio content in the audio signal. In alternate embodiments of the present invention however, an audio signal from a local audio source 120 can comprise secondary audio (e.g., audio clips) to be used to replace objectionable audio content in an audio signal. In such an embodiment, a control unit of the present invention, such as the control unit 110, applies the secondary audio provided within the audio signal when automatically replacing objectionable audio content in an audio signal. Alternatively, a control unit of the present invention, such as the control unit 110, can further include a means of voice synthesis for producing audio to replace objectionable audio content in an audio signal.

In an alternate embodiment of the present invention, a user can selectively define which locations of previously identified objectionable audio content in an input audio signal are to be automatically replaced. That is, in various embodiments of the present invention, a user identifies a particular type of objectionable audio content in an audio signal by identifying the objectionable audio content using specific codes. More specifically, as previously described, in various embodiments of the present invention, a user trains or teaches a control unit of the present invention, such as the control unit 110 of FIG. 1 and FIG. 2, what portions of an audio signal contains objectionable audio content. That is, a user initially uses the local audio source 120 to play the audio signal and, using the user input interface 210 identifies the locations of objectionable audio content in the audio signal. In such embodiments of the present invention, a user can identify and characterize objectionable audio content in an audio signal using predetermined codes. The predetermined codes identify the type of objectionable audio content and organize the objectionable audio content into categories, such as crude language, ethnic and racial slurs, cursing, strong profanity, and the like. The predetermined codes are respectively stored in the control unit, for example in the replacement content recording and identifier block 232, along with identifying information of the location of objectionable audio content to identify the category of respective objectionable audio content in an audio signal. In such embodiment of the present invention, when a user selects to activate the automatic replacement of objectionable audio content in an audio signal, the user is given access to a secondary, sub-menu.

FIG. 4 depicts a high level block diagram of an embodiment of a secondary, sub-menu in accordance with the present invention. As depicted in FIG. 4, when the automatic replacement of objectionable audio content in an audio signal is activated, a secondary, sub-menu is made available to the user. The secondary sub-menu enables a user to selectively identify which categories of the identified objectionable audio content in an audio signal to automatically replace. When a category of objectionable audio content is selected to be automatically replaced, the specific category of objectionable audio content is identified in the audio signal using the previously determined codes corresponding to the specific categories of objectionable audio content. As such, the specific categories of objectionable audio content identified or selected for automatic replacement will be replaced with the stored default previously recorded audio clip as described above. Alternatively, however, a recorded audio clip can be provided for each specific category of objectionable audio content and as such, each category of objectionable audio content selected for automatic replacement will be replaced with a stored, respective previously recorded audio clip for that category.

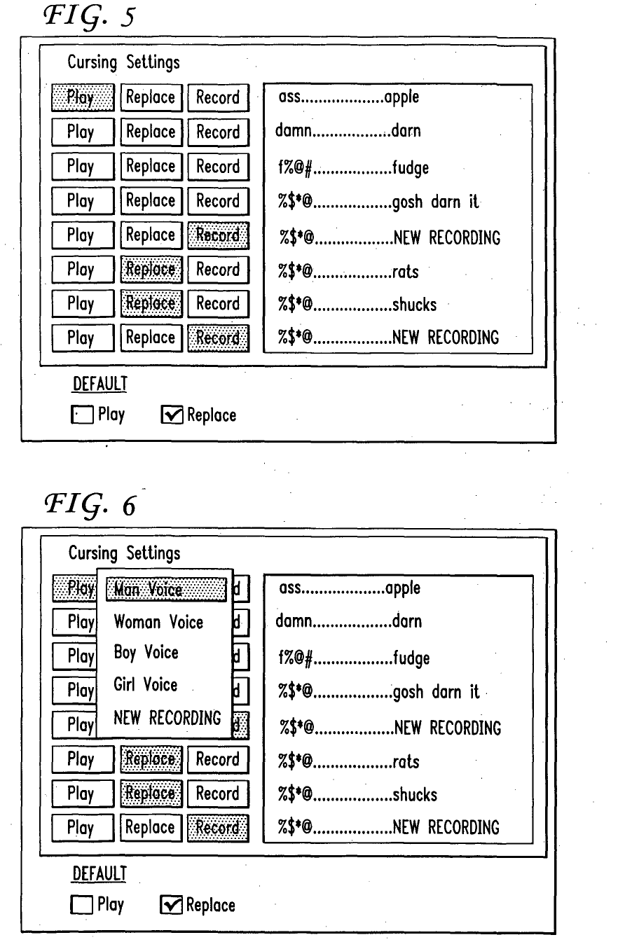

In higher-level embodiments of the present invention, a specific category of objectionable audio content can further be divided into sub-categories for identifying specific members of each category of objectionable audio content in an audio signal. For example, when a user selects to automatically replace a specific category of objectionable audio content in an audio signal, the user is given access to a further sub-menu. FIG. 5 depicts a high level block diagram of an embodiment of a member, sub-menu for a category of objectionable audio content of the menu of FIG. 4. As depicted in FIG. 5, when the automatic replacement of a specific category of objectionable audio content in an audio signal is activated (illustratively cursing in FIG. 5), a further, sub-menu is made available to the user. The sub-menu of FIG. 5 enables a user to selectively identify which listed members of a chosen category of the objectionable audio content in an audio signal to play or to automatically replace. A user is also able to select a default, play or automatically replace mode for members of the category not operated on or not listed. That is, as depicted in FIG. 5, a listed member of a selected specific category (illustratively cursing in FIG. 5) can be selected to either play or to be automatically replaced by a previously recorded audio clip intended for the replacement of the specific member of the selected specific category. Members of a category not having been operated on by a user or those not listed are automatically replaced or left to play depending on the default action selected. In addition and as depicted in FIG. 5, a user is able to record and store an audio clip for each member of a category and to use that recorded audio clip when automatically replacing the member of the category in an audio clip. A user accesses this functionality by activating the record button on the menu.

More specifically and as previously described, in various embodiments of the present invention, a user trains or teaches a control unit of the present invention what portions of an audio signal contains objectionable audio content. In addition and as described above, a user can further identify and characterize categories of objectionable audio content in an audio signal using predetermined codes. The predetermined codes identify the type of objectionable audio content and organize the objectionable audio content into categories. In the higher level embodiments of the present invention described above, for example with respect to FIG. 5, a user can further identify members of the determined specific categories of objectionable audio content using previously determined sub-codes. The previously determined sub-codes identify each of the members of the categories of objectionable audio content. As such, members of a category of objectionable audio content identified or selected for automatic replacement will be replaced as described above. That is, members of a category of objectionable audio content selected for automatic replacement will be replaced with a stored previously recorded audio clip identified for replacement of a specific category of objectionable audio content as described above. Alternatively, each member of a specific category can be respectively replaced with a previously recorded and stored audio clip provided for that specific member of a category of objectionable audio content.

Further higher level functions can be added to a control unit in accordance with the present invention. For example, in higher level embodiments of a control unit of the present invention, when a category or a member of a category of objectionable audio is selected for automatic replacement, a sub-window is enabled to allow a user to select from a gender list of previously recorded replacement audio clips to be used in the automatic replacement of the objectionable audio content selected for automatic replacement. For example, FIG. 6 depicts the sub-menu of FIG. 5 further comprising a sub-window for gender selection. That is, as depicted in FIG. 6, when a member of the cursing category depicted in FIG. 5 is selected for automatic replacement, a sub-window appears allowing a user to select from a gender list of previously recorded audio clips to be implemented when automatically replacing a selected member of a selected category. In such embodiments of the present invention, previously recorded audio clips to be implemented for the replacement of objectionable audio content must be stored for each of the selectable gender types made accessible by the sub-window.

Alternatively, in higher level embodiments of the present invention a user can identify the gender of objectionable audio content in an audio signal when training or teaching a control unit of the present invention as described above. That is, a specific code or sub-code can be recorded by the user to identify the gender of the speaker of objectionable audio content in an audio signal. As such, if that portion of objectionable audio is selected to be automatically replaced, a gender appropriate previously recorded audio clip can be selected to automatically replace the objectionable audio content using the code or sub-code of specific objectionable audio content to identify an appropriate corresponding recorded audio clip.

In the present invention, replacement audio clips can be recorded or selected from previously recorded and stored audio clips such that the duration of a replacement audio clip is substantially similar to the duration of the original audio in the audio signal such that disruption of the audio signal is minimized.

Referring back to FIG. 2 and as previously described, in the replacement content table compare block 233, a user's choices made, using the filter selection/activation interface, for whether or not an identified input audio signal (e.g., a previously trained audio signal) should be filtered and even further, for which portions of an identified input audio signal should be filtered (i.e., determined using menu selections as described above) are compared to a recorded list of objectionable audio content in the audio signal. If codes recorded in the list of objectionable audio content match any of the codes identifying a user's choices for which ones of the identified objectionable audio content locations of the audio signal are to be automatically replaced by the control unit 110, then the replacement content table compare block 233 communicates data to the replacement control block 234 that informs the replacement control block 234 that the objectionable audio content identified by the identified code is to be filtered out of the audio signal.

The replacement control block 234 controls the process of automatically replacing (filtering out) objectionable audio content from the audio signal based on the control signals received from the replacement content table compare block 233. When an audio replacement is made, the replacement control block 234 directs the audio replacement generation block 236 to provide an appropriate audio output from a library of pre-stored audio samples for the automatic replacement of identified objectionable audio and directs the switch block 237 to switch from a normal switch terminal 238 to a replacement switch terminal 239. Optionally, in alternate embodiments of the present invention, the audio replacement generation block 236 can instead synthesize a word to automatically replace objectionable audio content in an audio signal using audio synthesizing circuitry. The audio output of the switch block 237 is directed to the output device 130.

Referring back to FIG. 2 and as previously described, the replacement content recording and identifier block 232 of the control unit 110 examines the audio signal in an attempt to identify the audio signal. If the identification of the audio signal does not match a stored identification in the replacement content recording and identifier block 232 for a received audio signal, the control unit 110 is unable to perform the automatic replacement of objectionable audio content for that received audio signal. As such, in one embodiment of the present invention, when a control unit of the present invention, such as the control unit 110, receives an unidentifiable audio signal, the control unit 110 communicates a signal to the local audio source 120 to cause the local audio source to stop communicating the audio signal to the control unit (i.e., the control unit pauses the local audio source). A user is then prompted by the control unit 110 to determine if the user would like to teach or train the control unit 110 of the locations of the objectionable audio content for that particular unidentified audio signal. If the user responds negatively, the control unit 110 prompts the user to determine if the user would like to play the audio without automatic replacement of objectionable audio. If so, the control unit 110 prompts the user for a previously determined and stored password to allow the audio signal to again continue to play.

If however, the user desires to teach the control unit regarding the locations of objectionable audio content in the audio signal, the control unit 110 prompts the user to determine if the user has a predetermined source defining the locations of objectionable audio content in the audio signal (i.e., predetermined list from a subscription service, CD rom, etc.). If the user responds affirmatively, the control unit 110 prompts the user to enter the information manually or to input the media containing the information. If the user responds negatively, however, the control unit 110 communicates a signal to the local audio source 120 to restart the playing of the audio signal (i.e., to un-pause the local audio source). The user then trains or teaches the control unit 110 of the locations of objectionable audio content in the audio signal as described above.

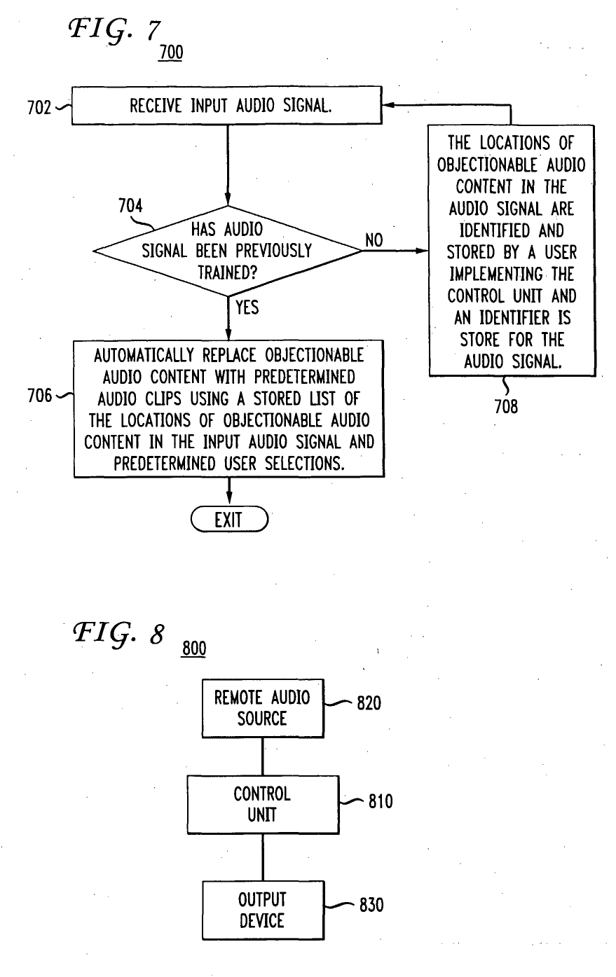

FIG. 7 depicts a method of automatically replacing objectionable audio content from an audio signal in accordance with one embodiment of the present invention. The method 700 of FIG. 7 is entered at step 702 where a control unit of the present invention receives an input audio signal. The method then proceeds to step 704.

At step 704, the control unit examines the audio signal to determine if it recognizes the audio signal. That is, the control unit determines if the audio signal is an audio signal that has been trained on the control unit (i.e., the objectionable audio content for that audio signal has been identified and the locations of the objectionable audio content has been stored), and determines if it has a stored list of the locations of objectionable audio content for that audio signal. If the input audio signal is recognized by the control unit, the method proceeds to step 706. If the input audio signal is not recognized by the control unit, the method proceeds to step 708.

At step 706, objectionable audio content in the input audio signal is automatically replaced with predetermined audio clips in real time using a stored list of the locations of objectionable audio content in the input audio signal and predetermined user selections. The method 700 is then exited.

At step 708, the locations of objectionable audio content in the audio signal are identified and stored by a user implementing the control unit as described above and an identifier is stored for the audio signal. As such, if the audio signal is received again by the control unit, the control unit is able to automatically replace objectionable audio content in the identifiable audio signal using a stored list of the locations of objectionable audio content in the audio signal and predetermined user selections. That is, the method 700 can then return to step 702.

FIG. 8 depicts a high level block diagram of a media system including a control unit 810 in accordance with an alternate embodiment of the present invention. More specifically, FIG. 8 depicts a media system 800 including a remote audio source 820, an output device 830 and a control unit 810 in accordance with an embodiment of the present invention. The media system 800 of FIG. 8 filters audio from the remote audio source 820 such that objectionable content is not communicated to the output device 830. In the media system 800 of FIG. 8, the remote audio source 820 can comprise substantially any source of remote audio such as a movie subscription service (e.g., HBO®, Cinemax®, an Online Movie Service, and the like), a music subscription service (e.g., XM Satellite Radio®, Sirius Satellite Radio®, Online Music Services, and the like), or other suitable audio source and the like. The output device 830 can comprise substantially any output device such as a display device for outputting video and audio information, a speaker system for outputting audio, and the like. Although in the media system 800 of FIG. 8, the control unit 810 of the present invention is depicted as comprising a stand-alone component, in alternate embodiments of the present invention, a control unit of the present invention can be integrated into a local output device, such as the output device 830 of the media system 800 of FIG. 8.

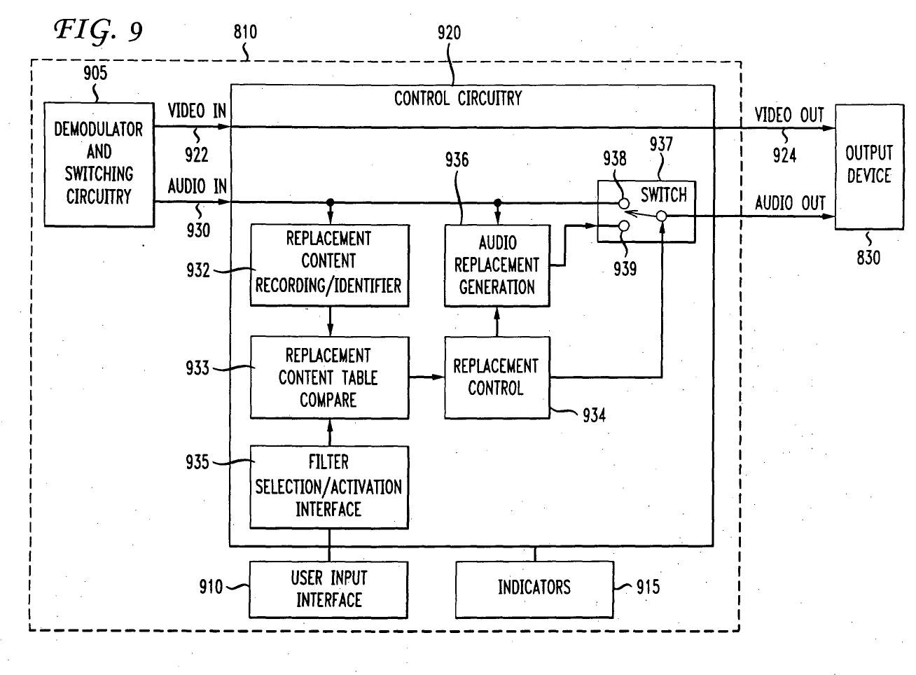

The control unit 810 of FIG. 8 comprises substantially the same components as the control unit 110 of FIG. 1 and FIG. 2 and operates in substantially the same manner. More specifically an unfiltered audio signal (e.g., movie audio, music video audio or stand alone audio, such as music) from the remote audio source 820 is received by the control unit 810. FIG. 9 depicts a high level block diagram of an embodiment of a control unit 810 suitable for use in the media system 800 of FIG. 8. That is, the control unit 810 of FIG. 9 illustratively comprises a demodulation and switching circuit 905, a user input interface 910, and control circuitry 920. The user input interface 910 of the control unit 810 can comprise wireless remote controls, pointing devices, such as a mouse or a trackball, voice recognition systems, touch screens, on screen menus, buttons, and the like. As depicted in FIG. 9, the control unit 810 of the present invention can also optionally comprise indicators 915. The indicators 915 are used to provide visible indications of the state of the control unit 810 to the user (i.e., to indicate when the control unit is performing filtering and at what level). The indicators 915 of a control unit of the present invention can comprise light emitting diodes, lamps, liquid crystal displays, and the like. The indicating functions of the indicators 915 can be provided by the control circuitry 920 of the control unit 810 to generate on-screen indicator images.

The demodulation and switching circuit 905 of the control unit 810 receives unfiltered signals from the remote audio source 820. The demodulation and switching circuit 905 demodulates the output signals from the remote audio source 820. Switching circuitry within the demodulation and switching circuit 905 directs audio signals from the output of the remote audio source 820 to the control circuitry 920 via a first signal path 907 and directs any video signals in the output of the remote audio source 820 to the control circuitry 920 via a second signal path 909. The demodulation and switching circuit 905 can be provided with suitable digital communications capabilities to handle digital information from sources such as the remote audio source 820.

The control circuitry 920 of the control unit 810 of FIG. 9 includes a video path 822 and an audio path 830. The video path 822 of the control unit 810 directs any input video signal to a video output 924 of the control unit 810. That is, no processing is performed by the control unit 810 on an input video signal. A video signal is fed through the control unit 810 to the video output 924 of the control unit 810 and ultimately to a video input of a video output device, such as a display device (not shown).

The audio path 930 of the control unit 810 comprises a replacement content recording and identifier block 932, a replacement content table compare block 933, a replacement control block 934, a filter selection/activation interface block 935, an audio replacement generation block 936 and a switch block 937. The functional blocks (e.g., replacement content recording block, filter selection/activation interface block, etc.) in the audio path 930 of the control unit 810 can be implemented in hardware, software, or a combination of hardware and software.

A user controls the settings of the control circuitry 920 by entering commands via the user input interface 910. As in the previous embodiments described above, in the present embodiment of the present invention, a user trains or teaches the control unit 810 what portions of an audio signal (e.g., a song or a movie) from the remote audio source 820 contains objectionable audio content. However in the embodiment of FIG. 8 having a remote audio source 820, there is no local timer for the audio signal and as such the control unit 810 must have a time reference for the audio signal to be able to identify the locations of objectionable audio content in the audio signal in a repeatable and reliable manner. As such, and in one embodiment of the present invention, the control unit 810 uses timing information in the audio signal from the remote audio source 820 as a reference for locating objectionable audio content in an audio signal.

In alternate embodiments of the present invention, a user can obtain timing information from the originators of the remote audio signal and use the obtained timing information to establish a starting point or starting position in the audio signal to establish the position of objectionable audio content in the audio signal by any of the means described herein. The remaining operation and functionality of the control unit 810 of FIG. 8 and FIG. 9 are substantially the same as in the plurality of embodiments of the present invention described above.

While the forgoing is directed to various embodiments of the present invention, other and further embodiments of the invention can be devised without departing from the basic scope thereof. As such, the appropriate scope of the invention is to be determined according to the claims, which follow.

1. A method for automatically replacing objectionable audio content from an audio signal in real time, comprising:
identifying objectionable audio content in said audio signal, wherein it is not necessary for said audio signal to comprise embedded information regarding the location of objectionable audio content in said audio signal;
determining a table of replacement events for at least said identified objectionable audio content based on at least one replacement setting, wherein each of the replacement events includes filtering information that corresponds to said at least one replacement setting; and
automatically replacing objectionable audio content in said audio signal with an audio clip corresponding to said at least one replacement setting when it is determined that objectionable audio content in said audio signal matches the filtering information defined in the table of replacement events.

2. The method of claim 1, wherein objectionable audio content in said audio signal is identified by reviewing said audio signal and marking the locations of objectionable audio content in said audio signal.

3. The method of claim 1, wherein objectionable audio content in said audio signal is identified from a stored list identifying at least the locations of objectionable audio content in said audio signal.

4. The method of claim 1, wherein objectionable audio content in said audio signal is identified from information regarding said audio signal retrieved from an outside source.

5. The method of claim 4, wherein the information regarding objectionable audio content in said audio signal is retrieved from an electronic media source.

6. The method of claim 1, further comprising storing an identifier for said audio signal such that information stored for identifying the objectionable audio content in said audio signal is again associated with said audio signal upon receiving said audio signal in the future.

7. An apparatus for automatically replacing objectionable audio content from an audio signal in real time, comprising:
an identifier and recording block for identifying objectionable audio content in said audio signal and for storing location and filtering information for said objectionable audio content, wherein it is not necessary for said audio signal to comprise embedded information regarding the location of objectionable audio content in said audio signal;
a replacement events table for at least said identified objectionable audio content based on at least one selected replacement setting, wherein each of the replacement events includes filtering information that corresponds to said at least one replacement setting;
a filter selection/activation interface for, in conjunction with a user interface, selecting replacement settings; and
a replacement controller for causing the automatic replacement of objectionable audio content in said audio signal with an audio clip stored in a audio replacement generation block, said audio clip corresponding to said at least one replacement setting, said automatic replacement occurring when it is determined that objectionable audio content in said audio signal matches the filtering information defined in the table of replacement events.

8. The apparatus of claim 7, further comprising demodulation and switching circuitry for separating said audio signal from a video signal.

9. The apparatus of claim 8, wherein said apparatus comprises separate audio and video paths.

10. The apparatus of claim 7, wherein said apparatus comprises indicators for providing visible indications of the state of the apparatus.

11. The apparatus of claim 7, wherein said replacement controller implements a switch for causing the automatic replacement of objectionable audio content in said audio signal.

12. A system for the automatic replacement of objectionable audio content from an audio signal in real time, comprising:
an audio source for providing an audio signal, wherein it is not necessary for said audio signal to comprise embedded information regarding the location of objectionable audio content in said audio signal;
a control unit for receiving said audio signal and automatically replacing objectionable audio content from said audio signal, said control unit including at least;
an identifier and recording block for identifying objectionable audio content in said audio signal and for storing location and filtering information for said objectionable audio content;
a replacement events table for at least said identified objectionable audio content based on at least one selected replacement setting, wherein each of the replacement events includes filtering information that corresponds to said at least one replacement setting;
a filter selection/activation interface for, in conjunction with a user interface, selecting replacement settings; and
a replacement controller for causing the automatic replacement of objectionable audio content in said audio signal with an audio clip stored in a audio replacement generation block to produce a filtered audio signal, said audio clip corresponding to said at least one replacement setting, said automatic replacement occurring when it is determined that objectionable audio content in said audio signal matches the filtering information defined in the table of replacement events; and
an audio output device for receiving said filtered signal from said control unit and outputting said filtered audio.

13. The system of claim 12, wherein said control unit is integrated into said audio source.

14. The system of claim 12, wherein said control unit is integrated into said audio output device.

15. The system of claim 12, wherein said audio source comprises an audio/video source and said control unit further comprises demodulation and switching circuitry for separating audio signals from video signals.
